(19) United States
(12) Patent Application Publication
(10) Pub. No.: US 2026/0074572 A1
(43) Pub. Date: Mar. 12, 2026

(54) POWER TRANSMISSION DEVICE, POWER SUPPLY SYSTEM, AND POWER SUPPLY METHOD

(71) Applicant: KABUSHIKI KAISHA TOSHIBA, Tokyo (JP)

(72) Inventors: Toshiya MITOMO, Yokohama Kanagawa (JP); Kentaro TANIGUCHI, Kawasaki Kanagawa (JP)

(73) Assignee: KABUSHIKI KAISHA TOSHIBA, Tokyo (JP)

(21) Appl. No.: 19/251,875

(22) Filed: Jun. 27, 2025

(30) Foreign Application Priority Data
Sep. 6, 2024 (JP) 2024-154198

(51) Int. Cl. H02J 50/90; H02J 50/23; H02J 50/80

(52) U.S. Cl. CPC H02J 50/90; H02J 50/23; H02J 50/80

(57) ABSTRACT

According to one embodiment, a power transmission device according to this embodiment includes: a receiver that receives a signal from a power receiving device via a plurality of antennas; a controller that detects a plurality of directions of arrival of the signal by performing direction-of-arrival estimation based on the received signal, and selects one of the directions of arrival; and a transmitter that performs transmission beamforming of a power signal with directivity toward the selected direction of arrival.

### CROSS REFERENCE TO RELATED APPLICATIONS

This application is based upon and claims the benefit of priority from the prior Japanese Patent Application No. 2024-154198, filed on Sep. 6, 2024, the entire contents of which are incorporated herein by reference.

### FIELD

The embodiments described herein relate to a power transmission device, a power supply system, and a power supply method.

### BACKGROUND

There are microwave power supply systems that perform wireless power transmission to a power receiving device using microwaves. To enable appropriate microwave beam transmission (beam direction control) even when the position of the power receiving device changes, a retro-directive method is known. In this method, weak beacon signals transmitted from the power receiving device are received by a plurality of antennas of the power supply device (hereinafter referred to as the power transmission device), and power is transmitted from the power transmission device to the power receiving device using conjugate signals of the phase and amplitude of the signals received by each antenna. By employing this technique, it becomes possible to perform beamforming that maximizes the power shared with the power receiving device.

However, when there are signal paths such as reflected waves in addition to the direct wave path between the power transmission device and the receiving device, channel estimation is carried out using channel information that includes a plurality of signal paths. As a result, during beamforming, microwaves may be radiated not only in the direction toward the receiving device (line-of-sight angle) but also in other directions. Therefore, if radio equipment using nearby frequency bands exists in such other directions, radio interference with those devices may occur. Furthermore, when the line-of-sight angle from the power transmission device to the receiving device is parallel or nearly parallel to the ground surface, a beam is generated along the ground direction. In such a case, a high-power signal may reach distant radio equipment, which can also lead to interference issues.

### BRIEF DESCRIPTION OF THE DRAWINGS

FIG. 1 is a block diagram showing an example of a power supply system according to the first embodiment.

FIG. 2 is an explanatory diagram of the operation of the controller in the power transmission device of the first embodiment.

FIG. 3 is an explanatory diagram of a comparative example for the first embodiment.

FIG. 4 is a block diagram showing an example of a power supply system according to the second embodiment.

FIG. 5 is an explanatory diagram of the operation of the controller in the power transmission device of the second embodiment.

FIG. 6 is an explanatory diagram of a comparative example for the second embodiment.

FIG. 7 is a block diagram showing an example of a power supply system according to the third embodiment.

FIG. 8 is a flowchart showing an example of operation in the third embodiment.

FIG. 9 is a block diagram showing an example of a power supply system according to the fourth embodiment.

FIG. 10 is an explanatory diagram of the operation of the controller in the power transmission device of the fourth embodiment.

FIG. 11 is an explanatory diagram of a comparative example for the fourth embodiment.

FIG. 12 is a block diagram showing an example of a power supply system according to the fifth embodiment.

FIG. 13 is a block diagram showing an example of a power supply system according to the sixth embodiment.

### DETAILED DESCRIPTION

The power transmission device of the present embodiment includes: a receiver configured to receive a signal from a power receiving device via a plurality of antennas; a controller configured to detect a plurality of directions of arrival of the signal by performing direction-of-arrival estimation based on the received signal and selects one of the plurality of directions of arrival; and a transmitter configured to perform transmission beamforming of a power signal with directivity toward the selected direction of arrival.

Hereinafter, this embodiment will be described in detail with reference to the drawings.

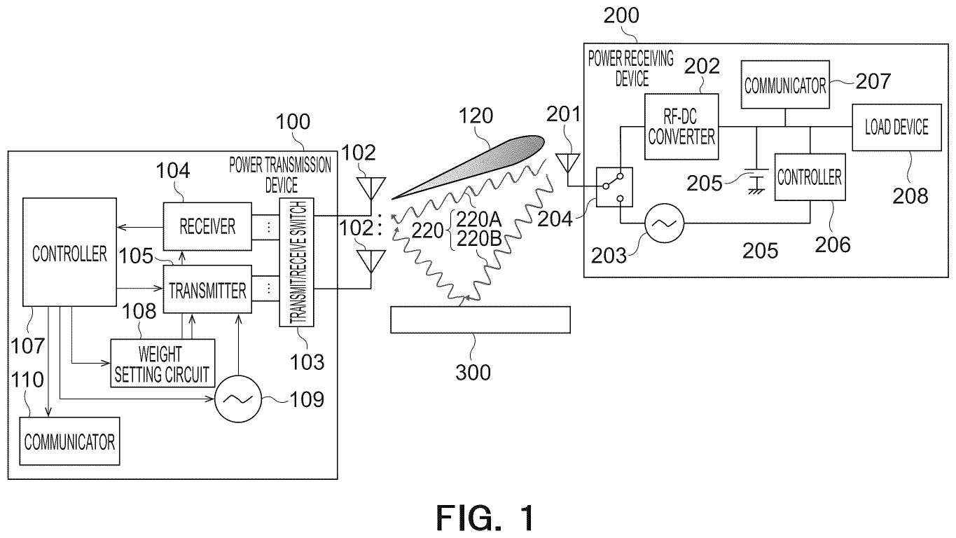

FIG. 1 is a block diagram showing an example of a power supply system according to this embodiment. The power supply system in FIG. 1 includes a power transmission device (power supply device) 100 and a power receiving device 200. Wireless power transmission (wireless power supply) is performed from the power transmission device 100 to the power receiving device 200 using electromagnetic waves such as microwaves. In the example of FIG. 1, the wireless power supply system includes only one power receiving device 200, but a plurality of power receiving devices 200 may also be included.

The power receiving device 200 may be any device that operates based on power supplied from the power transmission device 100. For example, the power receiving device 200 may be a sensor device mounted on a robot arm, a mobile object such as a vehicle, a camera for fixed-point observation, a sensor for monitoring processes in a factory, a pickup device for items in a distribution center, a control device for a door locking mechanism with auto-lock, or a smartphone.

### [Power Receiving Device 200]

The power receiving device 200 includes: one or more power receiving antennas 201; an RF-DC converter 202 (a rectifier, or a rectifier and a battery charging circuit, etc.); a beacon signal generator 203 (power receiving side transmitter); a transmit/receive switch 204; a battery 205; a controller 206; a communicator 207; and a load device 208. The load device 208 may also be provided externally to the power receiving device 200. The RF-DC converter 202, the beacon signal generator 203, the transmit/receive switch 204, the controller 206, and the communicator 207 are each implemented using at least one of an analog circuit that performs analog signal processing or a digital circuit that performs digital signal processing. The digital circuit may be implemented using a CPU (Central Processing Unit), DSP (Digital Signal Processor), general-purpose processor, microprocessor, ASIC (Application Specific Integrated Circuit), FPGA (Field Programmable Gate Array), or any combination thereof.

The transmit/receive switch 204 switches the connection destination of the antenna 201 between the RF-DC converter 202 and the beacon signal generator 203. During power reception, the antenna 201 is connected to the RF-DC converter 202, and during transmission, it is connected to the beacon signal generator 203.

The beacon signal generator 203 generates a beacon signal 220 of a predetermined frequency using an oscillator. When the transmit/receive switch 204 is switched to the beacon signal generator 203 side, the beacon signal generator 203 transmits the beacon signal 220 to the power transmission device 100 via the antenna 201. The beacon signal generator 203 functions as a transmitter for the beacon signal 220. The beacon signal 220 is a signal that includes a predetermined pattern and is used by the power transmission device 100 to estimate the channel (propagation path) to the power receiving device 200. Compared to the power signal (power supply signal) transmitted for power supply from the power transmission device 100, the beacon signal 220 may be a low-power signal. The signal containing the predetermined pattern may be an unmodulated signal or a signal without data, such as a sine wave signal. The transmission power of the beacon signal 220 is known to the power transmission device 100 and is, for example, predetermined. The frequency of the beacon signal 220 may be the same as or approximately the same as that of the power signal transmitted from the power transmission device 100. “Approximately the same” includes cases with an error of about 10%. In this embodiment, the antenna 201 is switched between transmission of the beacon signal 220 and reception of the power supply signal, but separate antennas may be provided for beacon signal transmission and power signal reception so that beacon signal transmission can be performed without switching antennas.

The RF-DC converter 202 is a rectifier that converts alternating current (AC) power into direct current (DC) power. When the transmit/receive switch 204 is switched to the RF-DC converter 202 side, the RF-DC converter 202 receives the AC power signal (power supply signal) 120 transmitted from the power transmission device 100, via the antenna 201. The RF-DC converter 202 converts the received AC power signal into DC power and outputs it. The power supply signal 120 is, for example, a microwave signal.

The battery 205 stores power based on the DC power output from the RF-DC converter 202. The stored power can be used as operating power for the communicator 207, the controller 206, the load device 208, the RF-DC converter 202, the beacon signal generator 203, and the transmit/receive switch 204.

The communicator 207 performs communication of information with the communicator 110 of the power transmission device 100. For example, the communicator 207 transmits information regarding the transmission power of the beacon signal (beacon power information) to the power transmission device 100 according to instructions from the controller 206. The transmission power may be, for example, the antenna power or equivalent isotropic radiated power (EIRP). Information such as the remaining battery level of the battery 205 may also be transmitted.

The wireless communication standard used by the communicator 207 may be arbitrary. For example, Bluetooth Low Energy (BLE), wireless LAN (Local Area Network), or the 920 MHz band communication standard may be used. The communicator 207 is provided with a communication antenna separate from the antenna 201 and communicates using the communication antenna. However, it is also possible for the communicator 207 to use the antenna 201 for performing communication.

The controller 206 performs overall control of the power receiving device 200 and, for example, controls at least one or all of the beacon signal generator 203, RF-DC converter 202, transmit/receive switch 204, and communicator 207. The controller 206 may control the beacon signal generator 203 to transmit a beacon signal to the power transmission device 100 in response to a beacon signal transmission request received by the communicator 207 from the power transmission device 100.

The beacon signal 220 includes a direct wave signal component 220A that is directly received by the power transmission device 100 from the power receiving device 200, and a reflected wave signal component 220B that is reflected by a reflector 300 and received by the power transmission device 100. The path through which the direct wave 220A of the beacon signal is received is referred to as the direct wave propagation path. The path through which the reflected wave 220B of the beacon signal is received is referred to as the reflected wave propagation path. Thus, the beacon signal 220 is transmitted to the power transmission device 100 via a plurality of paths (arrival paths). However, the reflected wave propagation path is not limited to one; two or more reflected wave propagation paths may exist.

### [Power Transmission Device 100]

The power transmission device 100 includes a plurality of antennas 102, a transmit/receive switch 103, a receiver 104, a transmitter 105 (transmission-side transmitter), a controller 107, a weight setting circuit 108, a high-frequency circuit 109, and a communicator 110. The transmit/receive switch 103, receiver 104, transmitter 105, controller 107, weight setting circuit 108, high-frequency circuit 109, and communicator 110 are each implemented using at least one of an analog circuit for analog signal processing or a digital circuit for digital signal processing. The digital circuit may be implemented using a CPU, DSP, general-purpose processor, microprocessor, ASIC, FPGA, or a combination thereof.

The power transmission device 100 operates based on power supplied from a commercial power source or from an external power storage device. However, the power transmission device 100 may also be equipped with an internal battery and operate based on the power stored in the battery.

The transmit/receive switch 103 switches the connection of the plurality of antennas 102 between the receiver 104 and the transmitter 105. During reception, the antennas 102 are connected to the receiver 104, and during transmission, they are connected to the transmitter 105.

The high-frequency circuit 109 (signal generator) includes a local oscillator that generates a local signal. Using this oscillator, the high-frequency circuit 109 generates a high-frequency signal (power signal) for power transmission to the power receiving device 200. The local signal is, for example, a high-frequency analog signal. The high-frequency circuit 109 sends the local signal generated by the local oscillator to the transmitter 105 as a power signal (power supply signal) 120. The high-frequency circuit 109 may also amplify the local signal using an amplifier before sending it to the transmitter 105 as the power supply signal 120. In addition, the high-frequency circuit 109 may perform frequency conversion of the local signal either before or after amplification and may further perform bandwidth control on the frequency-converted signal using a filter.

The communicator 110 communicates information with the communicator 207 of the power receiving device 200. For example, the communicator 110 receives information from the power receiving device 200 regarding the transmission power of the beacon signal. Additionally, the communicator 110 may receive information from the power receiving device 200 regarding the optimal power reception level for wireless power transfer. In this case, the controller 107 may control the generation of the power supply signal 120 so that it is received at the optimal power level by the power receiving device 200. The communicator 110 may also send a beacon signal transmission request to the power receiving device 200. The wireless communication standard used by the communicator 207 may be arbitrary.

The receiver 104 receives the beacon signal from the power receiving device 200 via the plurality of antennas 102 and performs analog-to-digital (A/D) conversion of the received beacon signal using an ADC. The receiver 104 may also amplify the received signal and adjust its bandwidth either before or after the A/D conversion.

The controller 107 performs overall control of the power transmission device 100, and controls at least one or all of the transmit/receive switch 103, receiver 104, transmitter 105, weight setting circuit 108, high-frequency circuit 109, and communicator 110.

The controller 107 detects the phase and amplitude of the signal for each antenna 102, or detects the phase difference and amplitude difference relative to predetermined values, and estimates the channel between each antenna 102 and the power receiving device 200. In this way, channel information representing the estimation result is obtained.

Based on the channel information for each antenna 102, the controller 107 estimates the direction of arrival of the beacon signal 220. Note that direction of arrival estimation refers to estimating the direction from which the beacon signal 220 arrives, and methods such as the MUSIC algorithm or other arbitrary estimation methods can be used.

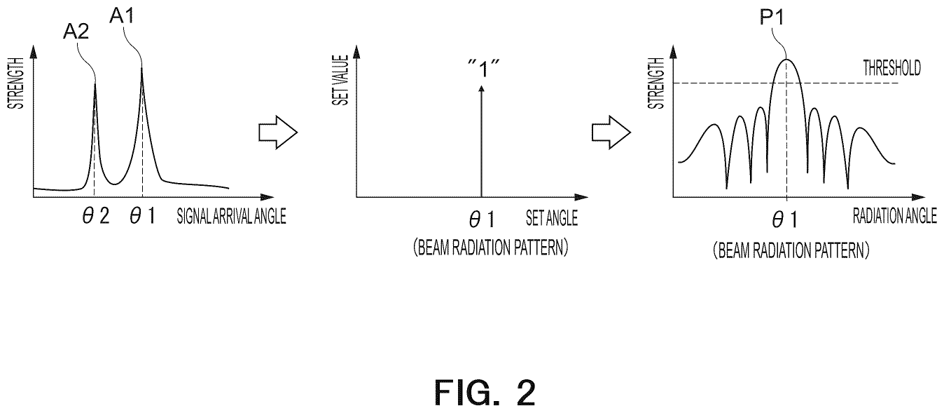

The left plot in FIG. 2 shows the result of direction of arrival estimation. The horizontal axis represents the angle of arrival, and the vertical axis represents the signal strength of the received signal (hereinafter also simply referred to as “strength”). The plot shows the distribution of signal strengths for a plurality of angles within the estimation range. Peaks A1 and A2 appear in the directions of angles of arrival θ1 and θ2, respectively. The directions of these peaks correspond to directions of arrival. The angle of arrival θ1 corresponds to the direction in which the direct wave 220A of the beacon signal is directly received (i.e., the direction of the line-of-sight propagation path). In other words, the angle of arrival θ1 corresponds to the direction of the angle from which the receiving device 200 is viewed from the transmitting device 100. The angle of arrival θ2 corresponds to the direction in which the reflected wave 220B of the beacon signal is received (i.e., the direction of the reflected propagation path). In other words, the angle of arrival θ2 corresponds to the direction of the angle from which the radio wave reflection point of the beacon signal on the reflecting object 300 is viewed from the transmitting device 100. In this manner, the direction-of-arrival estimation results include peaks not only at the arrival angles where the direct wave is received via the line-of-sight propagation path, but also at the arrival angles where the reflected wave is received via the reflected propagation path.

Based on the direction of arrival estimation result (DOA estimation result), the controller 107 selects one angle of arrival corresponding to the direction of the direct wave. It does not select the angle(s) corresponding to reflected wave directions. More specifically, the controller 107 determines the direction with the strongest peak in the estimation result to be the direction of arrival of the direct wave and selects it. It then determines the directions of peaks with the second strongest and weaker strengths to be directions of reflected waves and does not select them. In the example in the left plot of FIG. 2, since the strength at angle of arrival θ1 is the highest, the direction of angle θ1 is selected, and the direction of angle θ2, which has the second-highest strength, is not selected.

The center diagram of FIG. 2 illustrates an example of the operation of the controller 107 when selecting angle of arrival θ1. The controller 107 sets the value “1” for θ1, indicating that beam directivity is to be formed in that direction.

The controller 107 performs weight computation such that a directional beam (having a maximum peak) is formed in the direction of the angle of arrival where the value “1” was set, and determines the weight for each antenna 102. For the weight computation, a general three-dimensional beamforming method that forms a peak in a specific direction (solid angle) can be used. As a result, the transmission beam weights are determined such that the beam has directivity in the direction of θ1 (i.e., a peak with transmission power exceeding a threshold), and no directivity in the direction of θ2. Alternatively, weights may be computed such that a null is formed in the direction of θ2. The controller 107 sends the determined weights for each antenna 102 to the weight setting circuit 108. For example, a beam having directivity in the direction of θ1 has signal strength in the θ1 direction that is 1.5 times or more than that in other directions. This beam primarily uses the propagation path corresponding to θ1 for power transmission.

The weight setting circuit 108 sets the weights received from the controller 107 for each antenna 102 in the transmitter 105. The weights for each antenna 102 include adjustment values for phase and amplitude. However, it is also possible to adjust only one of either amplitude or phase.

The controller 107 controls the high-frequency circuit 109 to generate a high-frequency signal for power transmission. The high-frequency circuit 109 generates the high-frequency signal according to the instructions from the controller 107 and supplies the generated signal to the transmitter 105. The transmission power of the high-frequency signal may be predetermined. Alternatively, the controller 107 may acquire optimal reception power information from the power receiving device 200 via the communicator 110 and instruct the high-frequency circuit 109 to generate a high-frequency signal at a transmission power corresponding to that information.

The transmitter 105 adjusts the phase and amplitude of the high-frequency signal supplied from the high-frequency circuit 109 based on the weights for each antenna 102 to generate transmission signals for each antenna 102. The transmitter 105 performs digital-to-analog (D/A) conversion of the generated signals using DACs and quadrature frequency converters, and transmits them from the antennas 102. In this way, transmission beamforming of the power signal (supply signal) is performed so that it has directivity in the direction of the direct wave and no directivity in the direction of the reflected wave. The transmitter 105 may also perform operations such as bandwidth adjustment and amplification on the D/A converted signals before transmission. Although in this case the phase and amplitude are adjusted in the digital domain before D/A conversion, phase and amplitude adjustments may also be performed using RF phase shifters and variable gain amplifiers or variable attenuators, or by using RF-DACs.

The right diagram of FIG. 2 shows the radiation pattern of the beam transmitted from the transmitter 105. A peak P1 is present in the direction of angle of arrival (radiation angle) θ1, and there is no peak in the direction of θ2. The radiation strength in the direction of angle θ1 exceeds a threshold value, while the signal strengths in the direction of angle θ2 and other directions are below the threshold. As a result, the beam has a single large peak directed toward the power receiving device 200.

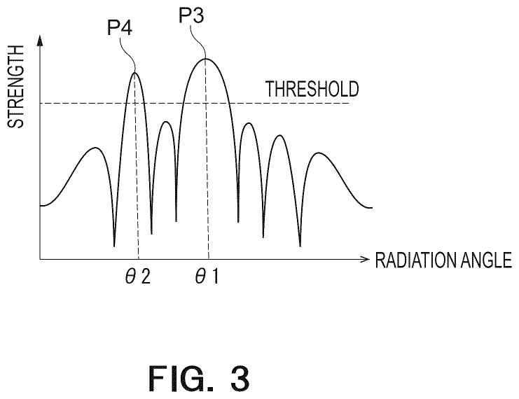

FIG. 3 shows, as a comparative example, a radiation pattern in which values of “1” are set for both angles of arrival (radiation angles) θ1 and θ2, thereby forming beams with directivity in both directions. Peaks P3 and P4 are present in the directions of θ1 and θ2, respectively, and both exceed the threshold in strength. Thus, a beam is transmitted with directivity in the direction of not only the direct wave (θ1) but also the reflected wave (θ2). Consequently, if another wireless device is present along the propagation path of the reflected wave, radio interference with that device may occur. In contrast, in this embodiment, as shown in the right diagram of FIG. 2, no directivity is formed in the direction of θ2. Therefore, even when another wireless device operating in a nearby frequency band exists along or near the reflected wave path, interference with such devices can be avoided or suppressed.

As described above, according to this embodiment, direction of arrival estimation is performed based on the beacon signal received from the power receiving device 200, and the direction (angle of arrival) corresponding to the direct wave is detected. A beam is then transmitted with directivity in the direction of the detected angle of arrival and with no directivity in the directions of other arrival angles. As a result, efficient power transmission can be achieved while suppressing radio interference with other wireless devices.

### Second Embodiment

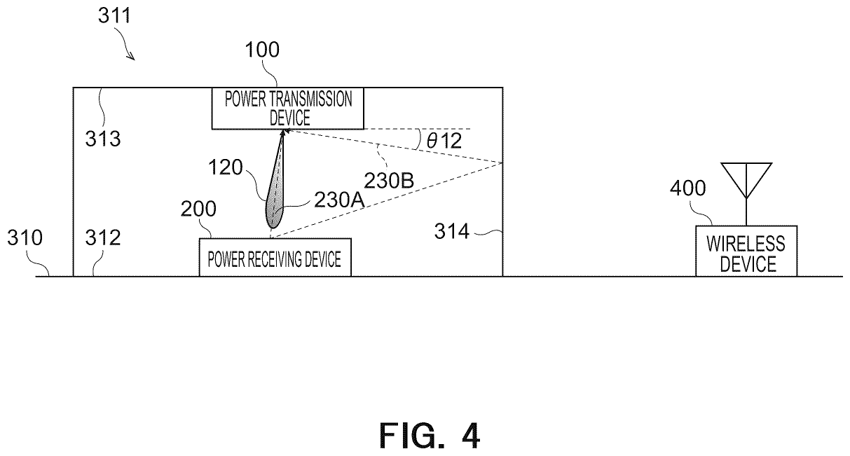

FIG. 4 is a block diagram showing an example of a power supply system according to the this embodiment. Elements having the same names as those in FIG. 1 are denoted by the same reference numerals, and descriptions are omitted as appropriate except for extended or modified processes. The following description focuses mainly on the differences from the first embodiment.

The power transmission device 100 is installed on the ceiling 313 inside a facility 311 that is built on the ground 310. The power receiving device 200 is installed on the floor 312 inside the facility 311. Another wireless device 400 is installed at a distant location away from the facility on the ground 310. Note that the other wireless device 400 may also be located inside the facility 311 or in another separate facility.

As in the first embodiment, the power receiving device 200 transmits a beacon signal. The transmitted beacon signal is received by the power transmission device 100 via a direct wave propagation path 230A as a direct wave, and also via a reflected wave propagation path 230B as a reflected wave reflected by a wall 314 inside the facility 311.

The controller 107 of the power transmission device 100 acquires channel information by estimating the channel based on the beacon signal received from the power receiving device 200, and then performs direction of arrival estimation based on the channel information. Based on the results of the direction of arrival estimation, all angles (angles of arrival) corresponding to peaks are detected.

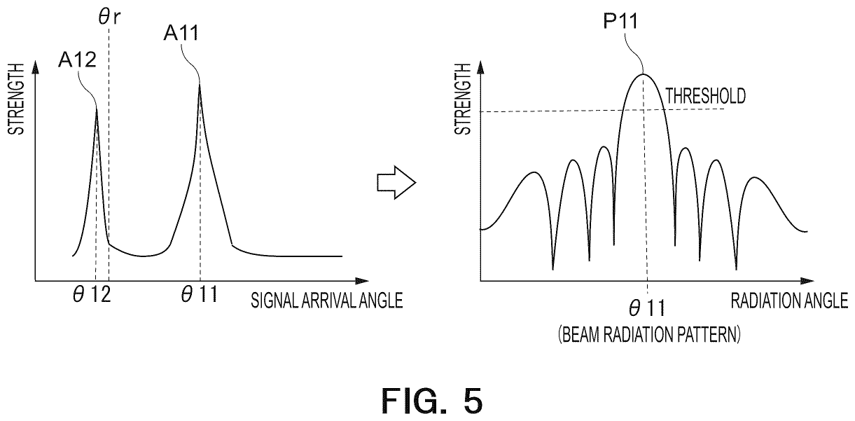

The left plot in FIG. 5 shows the result of the direction of arrival estimation. The horizontal axis represents the angle of arrival, and the vertical axis represents the strength of the received signal. Peaks A11 and A12 appear in the directions of angles of arrival θ11 and 012, respectively. Angle of arrival θ11 corresponds to the direction in which the direct wave of the beacon signal is received, i.e., the direction of the direct wave propagation path 230A. Angle of arrival θ12 corresponds to the direction in which the beacon signal is reflected by the wall 314 and received, i.e., the direction of the reflected wave propagation path 230B.

The controller 107 of the power transmission device 100 determines whether a direction of arrival (which may be simply called an arrival direction) corresponding to each detected peak is within a threshold angle relative to the horizontal direction as seen from the power transmission device 100. More specifically, it determines whether the angle relative to the horizontal direction parallel to the ground surface or to the mounting surface of the power transmission device 100 is less than or equal to a threshold. The threshold is not limited to a specific value, but may be, for example, 5°, 7°, or 10°. The threshold may also be determined based on directions in which the power receiving device 200 is unlikely to be located. The controller 107 selects only the peaks (arrival directions) whose angles exceed the threshold and does not select the peaks whose angles are less than or equal to the threshold. Alternatively, it may select the arrival direction furthest from the horizontal direction among all peaks, or select the arrival direction corresponding to the strongest peak among the peaks of angles exceeding the threshold.

In the example of the left plot of FIG. 5, angle of arrival θ12 is smaller than the threshold θr, while angle of arrival θ11 is greater than the threshold θr. Therefore, the controller 107 selects the direction of angle θ11 and does not select the direction of angle θ12. The controller 107 determines the direction of angle θ11 as the direction to form the beam directivity for transmission.

The controller 107 calculates weights for each antenna 102 such that a beam is formed with directivity in the direction of angle θ11 and no directivity in the direction of angle θ12. The weight setting circuit 108 sets the calculated weights in the transmitter 105. The transmitter 105 transmits a beam based on the set weights, with directivity in the direction of angle θ11 and no directivity in the directions of other angles, including θ12. As a result, radiation in the direction parallel or nearly parallel to the ground surface 310 is suppressed, and interference with other wireless devices 400 located far outside the facility 311 can be reduced.

The right plot in FIG. 5 shows the radiation pattern of the beam transmitted from the transmitter 105 of the power transmission device 100. A peak P11 appears in the direction of angle of arrival (radiation angle) θ11, while no peak appears in the direction of angle θ12. The radiation power strength in the direction of θ11 is above the threshold, while the radiation power strength in the directions of θ12 and other angles is below the threshold. As a result, a beam with a single large peak directed toward the power receiving device 200 is transmitted.

If a beam with a peak above the threshold were also transmitted in the direction of angle θ12, the non-reflected component of the power signal in that direction could reach the other wireless device 400, potentially causing radio interference.

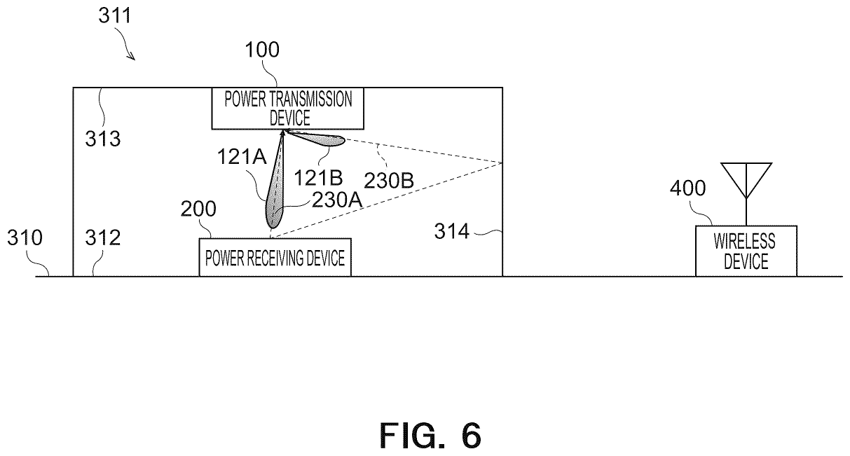

FIG. 6 shows a comparative example in which a beam 121 (comprising components 121A and 121B) is transmitted with directivity in both the direction of angle θ11 and the direction of angle θ12. The beam 121 includes a beam component 121A in the direction of θ11 and a beam component 121B in the direction of θ12. The non-reflected portion of beam component 121B in the direction of θ12 may reach the other wireless device 400. Because the power signal is significantly stronger than the beacon signal, radio interference that does not occur with weak beacon signals may occur with the power signal. In contrast, in this embodiment, as shown in the right plot of FIG. 5, no directivity is formed in the direction of θ12, so such interference can be avoided or reduced.

As described above, according to this embodiment, transmission beamforming is performed in such a manner that radiation power in the direction parallel or nearly parallel to the ground surface or the mounting surface of the power transmission device 100 is suppressed. As a result, radiation toward distant other wireless devices 400 is reduced, and radio interference can be avoided or mitigated.

### Third Embodiment

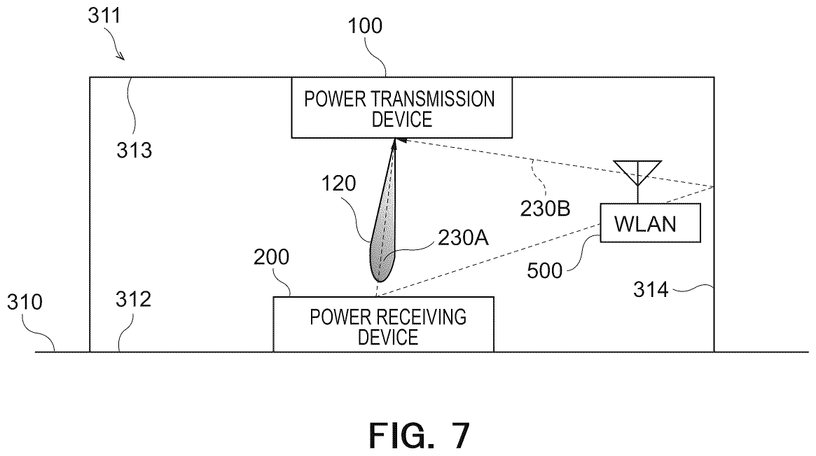

FIG. 7 is a block diagram showing an example of a power supply system according to this embodiment. Elements with the same names as those in FIG. 4 are denoted by the same reference numerals, and descriptions are omitted as appropriate except for extended or modified processes. The following description focuses on differences from the second embodiment.

Unlike the block diagram in FIG. 4, in this embodiment, one or more wireless LAN (Local Area Network) devices 500 are installed inside the facility 311. There are no other wireless devices 400 installed outside the facility 311.

The wireless LAN device 500 is located on or near the reflected wave propagation path 230B of the beacon signal.

As in the second embodiment, the beacon signal transmitted from the power receiving device 200 is received by the power transmission device 100 both as a direct wave via the direct wave propagation path 230A and as a reflected wave via the reflected wave propagation path 230B, which is reflected by the wall 314 inside the facility.

The controller 107 of the power transmission device 100 acquires channel information by estimating the channel based on the beacon signal received from the power receiving device 200, and further performs direction of arrival estimation using the channel information. The result of the direction of arrival estimation is similar to that shown in the left plot of FIG. 5, as in the second embodiment.

The controller 107 of the power transmission device 100 detects all directions (arrival directions) corresponding to the peaks in the direction of arrival estimation result. For each detected arrival direction, the controller 107 calculates a weight that forms a beam having directivity only toward that arrival direction—that is, a weight that provides higher reception sensitivity for that direction than for the others. Using the calculated weights for each detected arrival direction, the controller 107 performs carrier sensing for the frequency used in the transmission beamforming. Based on the result of the carrier sensing, it selects an arrival direction in which no carrier was detected (i.e., where no wireless LAN usage was detected). The weight setting circuit 108 sets in the transmitter 105 the weight corresponding to the selected arrival direction.

The transmitter 105 performs beamforming and transmits the power signal based on the set weight. In this way, a beam is transmitted with directivity in the selected arrival direction and without directivity in the other directions.

If a plurality of arrival directions are found where no carrier was detected in the carrier sensing result, the direction with the strongest peak among them may be selected, or the arrival direction with the greatest angle from the horizontal direction (i.e., the direction most distant from the plane of the ground or the mounting surface of the power transmission device 100) may be selected.

By performing beamforming with directivity toward an arrival direction where no carrier was detected according to the carrier sensing result, radio interference with the wireless LAN device 500 located on or near the beacon signal's propagation path can be reduced. Additionally, the power transmission device 100 may perform carrier sensing, prior to power transmission, using weights that provide directivity only toward an arrival direction where no carrier was detected. Thus, in systems that perform power transmission only when no carrier is detected, the likelihood of detecting wireless LAN radio signals is reduced. This is because weights are applied to form directivity only toward an arrival direction where no carrier has been detected, thereby preventing a reduction in power transmission opportunities.

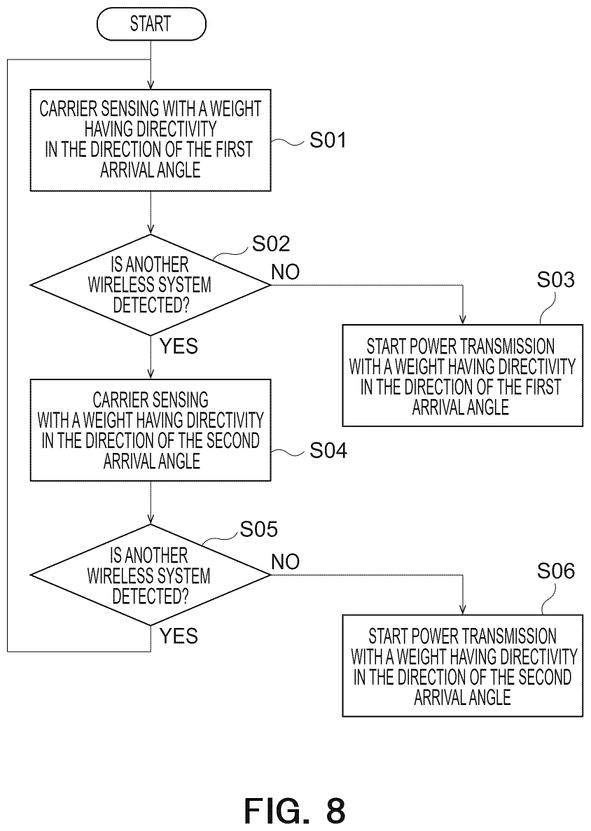

FIG. 8 is a flowchart showing an example of the operation of the power transmission device 100 in this embodiment. It assumes a case where a plurality of peaks are detected from the result of the direction of arrival estimation for the beacon signal. Among the plurality of angles of arrival with peaks, a first arrival angle (which corresponds to a first direction of arrival) is selected, and weights are generated to form a beam with directivity only toward that first arrival angle (i.e., having radiation power above a threshold), and carrier sensing is performed using the weights (S01). If no carrier is detected as a result of the carrier sensing (i.e., no use by a wireless LAN or other wireless system is detected), power transmission is started using the weights corresponding to the first arrival angle (S03). If a carrier is detected (i.e., use of the frequency by a wireless LAN or other wireless system is detected), a second arrival angle (which corresponds to a second direction of arrival) is selected. Weights are generated to form a beam with directivity only toward the second arrival angle, and carrier sensing is performed using these weights (S04). If no carrier is detected, power transmission is started using the weights for the second arrival angle (S06). If a carrier is detected, the process returns to step S01 to retry with the first arrival angle. If a third arrival angle (which corresponds to a third direction of arrival) exists, the same process may be repeated for it. In this way, the arrival direction is selected repeatedly until one is found with no carrier detected. Additionally, if power receiving devices other than the power receiving device 200 are available for power transmission, the target device may be switched accordingly. This flow allows the system to select a power transmission path that avoids or reduces interference with other wireless devices in scenarios where a plurality of power transmission paths exist.

### Fourth Embodiment

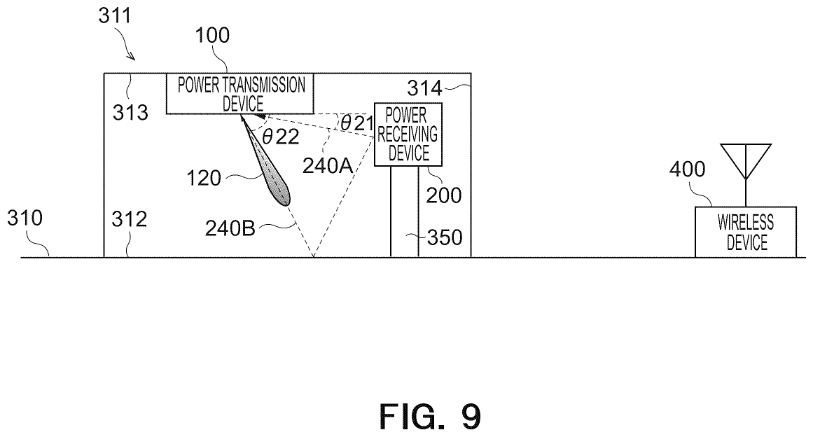

FIG. 9 is a block diagram showing an example of a power supply system according to this embodiment. Elements with the same names as those in FIG. 4 are denoted by the same reference numerals, and descriptions are omitted as appropriate except for extended or modified processes. The following description focuses on differences from the second embodiment.

Unlike the block diagram in FIG. 4, in this embodiment, the power receiving device 200 is not installed on the floor 312 inside the facility 311, but is supported at a position higher than the floor 312 by a support stand 350.

The beacon signal transmitted from the power receiving device 200 is received by the power transmission device 100 both as a direct wave via the direct wave propagation path 240A and as a reflected wave via the reflected wave propagation path 240B, which is reflected by the floor 312 inside the facility.

The controller 107 of the power transmission device 100 acquires channel information by estimating the channel based on the beacon signal received from the power receiving device 200, and further performs direction of arrival estimation using the channel information. Based on the direction of arrival estimation result, it detects all directions (arrival directions) corresponding to the peaks.

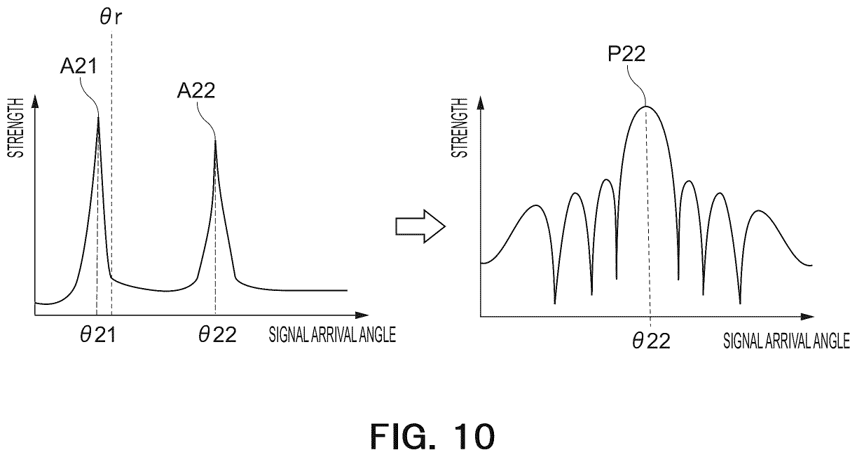

The left plot in FIG. 10 shows the result of the direction of arrival estimation. The horizontal axis represents the angle of arrival, and the vertical axis represents the signal strength of the received signal. Peaks A21 and A22 appear in the directions of arrival angles θ21 and θ22, respectively. Angle of arrival θ21 corresponds to the direction in which the direct wave of the beacon signal is received (i.e., the direction of the direct wave propagation path 240A). Angle of arrival θ22 corresponds to the direction in which the reflected wave of the beacon signal is received (i.e., the direction of the reflected wave propagation path 240B).

The controller 107 of the power transmission device 100 determines whether the direction (arrival angle) of each detected peak is less than or equal to a threshold relative to the horizontal direction of the ground or the mounting surface of the power transmission device 100. The threshold may be determined in the same manner as in the second embodiment. The controller 107 selects only the arrival directions of the peaks that exceed the threshold and does not select those that are equal to or below the threshold.

In the example of the left plot in FIG. 10, the direction of the reflected wave θ22 exceeds the threshold θr, whereas the direction of the direct wave θ21 is below the threshold. Therefore, the controller 107 selects the direction of arrival θ22 and does not select the direction of arrival θ21. The controller 107 sets the direction of θ22 (the reflected wave propagation path 240B) as the direction to form the beam directivity for transmission.

The controller 107 calculates weights for each antenna 102 such that the beam has directivity in the direction of θ22 and no directivity in other directions including θ21. The weight setting circuit 108 sets the calculated weights in the transmitter 105. The transmitter 105 adjusts the transmission signal based on the weights and transmits a power signal as a beam having directivity only in the direction of θ22. Since the power signal is transmitted via the reflected wave propagation path 240B, the power transmission efficiency to the power receiving device 200 is reduced. However, because radiation in the direction along the ground is suppressed, radio interference with other wireless devices 400 outside the facility 311 can be reduced.

The right plot in FIG. 10 shows the radiation pattern of the beam transmitted from the transmitter 105 of the power transmission device 100. A peak P22 appears in the direction of angle of arrival (radiation angle) θ22, and no peak appears in the direction of θ21. As a result, even though the beam propagates via the reflected wave propagation path 240B, it is transmitted with a single, large peak directed toward the power receiving device 200. Since no directivity is formed in the direction of the direct wave propagation path 240A, interference with other wireless devices 400 can be effectively suppressed.

As a comparative example, consider the case where a beam is transmitted with directivity in both the direction of angle θ22 and angle θ21. In this case, the non-reflected component of the power signal in the direction of θ21 may reach the other wireless device 400, causing radio interference.

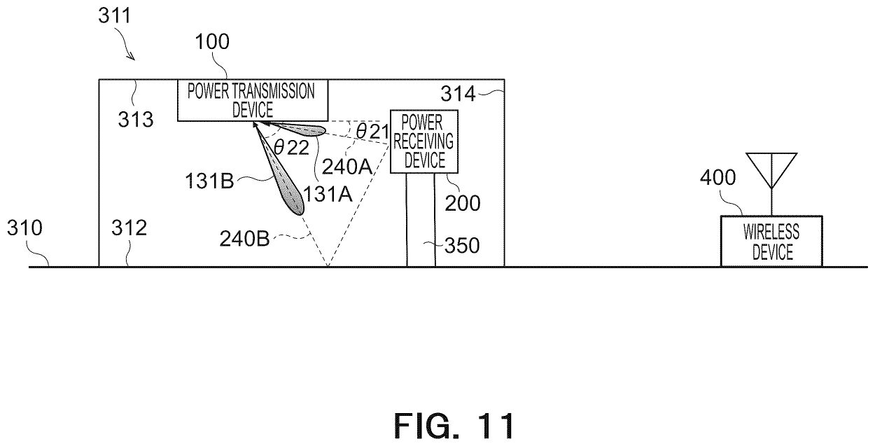

FIG. 11 shows a comparative example in which a beam 131 (comprising components 131A and 131B) is transmitted with directivity in both the direction of angle θ21 and the direction of angle θ22. The beam 131 includes a direct wave 131A with directivity toward angle θ21 and a reflected wave 131B with directivity toward angle θ22. The non-reflected component of the direct wave 131A may reach the other wireless device 400. Because the power signal is significantly stronger than the beacon signal, radio interference that would not occur with weak beacon signals may occur. In contrast, in this embodiment, as shown in FIG. 10, directivity is not formed in the direction of angle θ21, and therefore such interference can be avoided or reduced.

As described above, according to this embodiment, a beam is transmitted from the power transmission device 100 in a way that suppresses directivity along directions parallel to the ground or similar surfaces. As a result, radiation toward distant other wireless devices 400 is reduced, and radio interference can be avoided or mitigated. Specifically, if the direction of the direct wave propagation path corresponds to the ground direction, directivity in that direction is suppressed and a beam is transmitted with directivity in the direction of the reflected wave propagation path instead. While this may reduce transmission efficiency, it enables avoidance or reduction of radio interference with other wireless devices.

### Fifth Embodiment

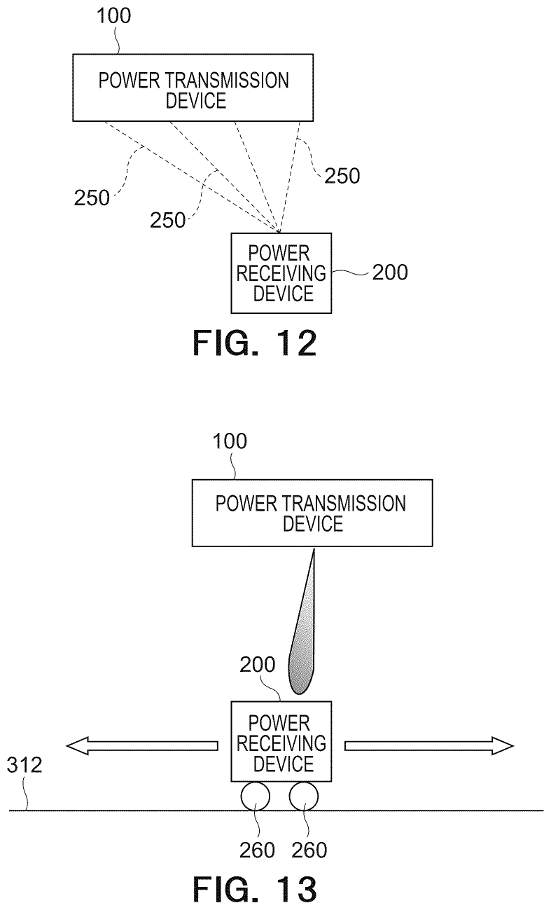

FIG. 12 is a block diagram showing an example of a power supply system according to this embodiment. Elements with the same names as those in FIG. 1 are denoted by the same reference numerals, and descriptions are omitted as appropriate except for extended or modified processes. The following description focuses on differences from the first embodiment. In this embodiment, it is assumed that the power receiving device 200 is located in the near field of the power transmission device 100, and that the distances between each antenna 102 of the power transmission device 100 and the antenna 201 of the power receiving device 200 differ. FIG. 12 shows the direct wave propagation path 250 between each antenna 102 of the power transmission device 100 and the antenna 201 of the power receiving device 200. In this example, it is assumed that there are four antennas 102, but the number of antennas may be 2, 3, or 5 or more. Although reflected wave propagation paths may also exist in addition to the direct wave propagation path 250, they are omitted from the illustration.

The controller 107 of the power transmission device 100 estimates the channel and the angle of arrival based on the beacon signal received from the power receiving device 200 and calculates the angle of arrival corresponding to the direct wave propagation path. This allows the azimuth angle θ and elevation angle φ to be calculated for the power receiving device 200. In addition, the distance r between the power transmission device 100 and the power receiving device 200 is calculated based on the reception strength of the beacon signal. As a result, the position (coordinate values) of the power receiving device 200 relative to the power transmission device 100 can be obtained as (r, θ, φ).

Based on the coordinate values of each antenna 102 and the coordinate values of the power receiving device 200 (r, θ, φ), the controller 107 calculates the distance between each antenna 102 and the power receiving device 200. More specifically, it calculates the distance between each antenna 102 and the antenna 201 of the power receiving device 200. Based on these distances, the controller 107 determines weights for each antenna 102 so that the phases of the signals transmitted from each antenna 102 coincide when received at the antenna 201 of the power receiving device 200. The term “coincide” also includes cases with an error of about 5% or 10%. Note that, as in the first embodiment, if beacon signals are received via a reflected wave propagation path in addition to the direct wave propagation path, weights for each antenna 102 are calculated such that the beam has no directivity (peak) in the direction of the reflected wave propagation path.

The weight setting circuit 108 sets the calculated weights for each antenna 102 in the transmitter 105. The transmitter 105 adjusts the phase and amplitude of the signal transmitted from each antenna 102 based on the set weights and transmits the signals. As a result, a power signal beam is transmitted with directivity toward the power receiving device 200 and no directivity toward the reflected wave propagation path.

As described above, in this embodiment, by reflecting the differences in distances between each antenna 102 and the power receiving device 200 in the weights assigned to each antenna 102, power can be transmitted more efficiently to the power receiving device 200 than by using a general three-dimensional beamforming method targeting a specific direction (solid angle). The general three-dimensional beamforming method assumes the same distance between each antenna 102 and the power receiving device 200 when computing the weights, making it effective for far-field power transmission where this assumption holds. However, in the near field, where distances vary significantly, this assumption leads to reduced power transmission efficiency. In contrast, as in this embodiment, by accounting for distance differences in the weight calculations for each antenna 102, it becomes possible to transmit a larger amount of power to the power receiving device 200.

### Sixth Embodiment

This embodiment relates to the case where the power receiving device 200 in any of the first through fifth embodiments is mobile with respect to the power transmission device 100—that is, when the power receiving device 200 is mounted on a moving object or a moving vehicle.

FIG. 13 is a block diagram showing an example of a power supply system according to this embodiment. Elements with the same names as those in FIG. 1 are denoted by the same reference numerals, and descriptions are omitted as appropriate except for extended or modified processes.

The power receiving device 200 is a mobile object that can move across the floor 312 inside the facility in the direction indicated by the arrow in the figure. The mobile object is equipped with wheels 260 for movement. The power receiving device 200 may move along a predetermined route at a constant speed. For example, the power receiving device 200 may be a vehicle that repeatedly moves back and forth within a defined range on rails.

The controller 107 of the power transmission device 100 has a function to predict the position of the power receiving device 200 at a future time or timing. Prediction methods may include machine learning techniques such as generating a position prediction model, artificial intelligence (AI) using neural networks, or statistical approaches, as well as other techniques.

A camera may be mounted on the power transmission device 100, and image data obtained by capturing the power receiving device 200 may be used for prediction. The power transmission device may also communicate with the power receiving device 200 to obtain information necessary for prediction. If a moving plan including the movement path and time of the mobile object is predetermined, then schedule information including this movement plan may be acquired. Alternatively, the battery level (battery information) or power meter value (meter information) of the mobile object or power receiving device 200 may be acquired. If the movement speed of the mobile object changes depending on the battery level, the speed can be estimated from the battery information or meter information, and the position of the mobile object at a future time may be predicted based on the estimated speed.

The controller 107 of the power transmission device 100 considers the movement of the mobile object during the processing time required for direction-of-arrival estimation and weight calculation, predicts the position of the mobile object at the timing of power signal transmission, and calculates weights appropriate for that predicted position. In this manner, even if the power receiving device 200 is moving, efficient power supply can be continuously performed. Additionally, the number of times direction-of-arrival estimation and weight computation must be executed can be reduced. Furthermore, in this embodiment as well, radio interference with external wireless devices can be avoided or reduced, as in the first through fifth embodiments.

The embodiments as described before may be configured as below.

### Clauses

Clause 1. A power transmission device comprising:
a receiver configured to receive a signal from a power receiving device via a plurality of antennas;
a controller configured to detect a plurality of directions of arrival of the signal by performing direction-of-arrival estimation based on the received signal and selects one of the plurality of directions of arrival; and
a transmitter configured to perform transmission beamforming of a power signal with directivity toward the selected arrival direction.

Clause 2. The power transmission device according to clause 1, wherein in the transmission beamforming, a signal strength of radiation in the selected direction of arrival is equal to or greater than a threshold, and a signal strength of radiation in other arrival directions different from the selected direction of arrival is less than the threshold.

Clause 3. The power transmission device according to clause 1 or 2, wherein the controller selects, from among the plurality of directions of arrival, a direction of arrival having the highest received signal strength.

Clause 4. The power transmission device according to clause 1 or 2, wherein the controller selects, from among the plurality of directions of arrival, a direction of arrival having an angle difference from a direction parallel or horizontal to a mounting surface of the power transmission device which is greater than a threshold.

Clause 5. The power transmission device according to clause 1 or 2, wherein the controller selects, from among the plurality of directions of arrival, the direction of arrival having a greatest angle difference from a direction parallel or horizontal to a mounting surface of the power transmission device.

Clause 6. The power transmission device according to any one of clauses 1 to 5, wherein the controller sets a first weight for the selected direction of arrival to be higher than a second weight for other directions of arrival, performs carrier sensing at a radio frequency used for the transmission beamforming based on reception sensitivity according to the first and second weights, and selects a direction of arrival if no carrier is detected.

Clause 7. The power transmission device according to any one of clauses 1 to 6, wherein the controller:
sets a first weight for the selected direction of arrival to be higher than a second weight for other directions of arrival;
performs first carrier sensing at a radio frequency used for the transmission beamforming based on reception sensitivity according to the first and second weights; and
if a carrier is detected, sets a third weight for another arrival direction other than the one arrival direction among the plurality of arrival directions higher than a fourth weight for remaining arrival directions other than said another arrival direction, and
performs a second carrier sense at the radio frequency used for the transmission beamforming based on a reception sensitivity according to the third and fourth weights.

Clause 8. The power transmission device according to any one of clauses 1 to 7, wherein
the controller:
   detects a position of the power receiving device based on the signal;
   calculates distances between the plurality of antennas and the power receiving device based on the positions of the antennas and the power receiving device; and
   determines weights for the antennas such that phases of signals transmitted from the antennas coincide at the power receiving device; and
the transmitter performs transmission beamforming of the power signal based on the weights.

Clause 9. The power transmission device according to any one of clauses 1 to 8, wherein the controller predicts a position of the power receiving device, which is mounted on a mobile object, for each future timing based on information obtained from the mobile object, and adjusts the selected direction of arrival based on the predicted position to perform transmission beamforming of the power signal.

Clause 10. The power transmission device according to clause 9, wherein the information obtained from the mobile object includes at least one of:
captured image data obtained by imaging the mobile object with a camera,
meter information or battery level information of the mobile object, or
movement schedule information of the mobile object.

Clause 11. The power transmission device according to any one of clauses 1 to 10, wherein in the direction-of-arrival estimation, the controller calculates a distribution of signal strength by angle based on the received signal, and detects an angle having a peak in the distribution as the direction of arrival.

Clause 12. The power transmission device according to any one of clauses 1 to 11, wherein the signal received by the receiver includes signals received via a plurality of propagation paths from the power receiving device.

Clause 13. The power transmission device according to any one of clauses 1 to 12, wherein the signal is a beacon signal.

Clause 14. A power transmission method comprising:
receiving a signal from a power receiving device via a plurality of antennas;
detecting a plurality of directions of arrival of the signal by performing direction-of-arrival estimation based on the received signal;
selecting one of the plurality of directions of arrival; and
performing transmission beamforming of a power signal with directivity toward the selected direction of arrival.

Clause 15. A power supply system comprising a power transmission device and a power receiving device, wherein:
the power receiving device includes a receiving-side transmitter configured to transmit a signal to the power transmission device;
the power transmission device includes:
   a receiver configured to receive the signal from the power receiving device via a plurality of antennas;
   a controller configured to detect a plurality of directions of arrival of the signal by performing direction-of-arrival estimation based on the received signal, and selects one of the plurality of directions of arrival; and
   a transmission-side transmitter configured to perform transmission beamforming of a power signal with directivity toward the selected direction of arrival; and
the power receiving device includes:
   a receiver configured to receive the power signal from the power transmission device; and
   a battery configured to store power based on the power signal.

Note that the present invention is not limited to the embodiments as described above, and can be embodied by modifying components without departing from its spirit at the implementation stage. In addition, various inventions can be formed by appropriate combinations of a plurality of components disclosed in the above-described embodiments. For example, some components may be deleted from all the components shown in the embodiments. Furthermore, components from different embodiments may be appropriately combined.

1. A power transmission device comprising:
a receiver configured to receive a signal from a power receiving device via a plurality of antennas;
a controller configured to detect a plurality of directions of arrival of the signal by performing direction-of-arrival estimation based on the received signal and selects one of the plurality of directions of arrival; and
a transmitter configured to perform transmission beamforming of a power signal with directivity toward the selected arrival direction.

2. The power transmission device according to claim 1, wherein in the transmission beamforming, a signal strength of radiation in the selected direction of arrival is equal to or greater than a threshold, and a signal strength of radiation in other arrival directions different from the selected direction of arrival is less than the threshold.

3. The power transmission device according to claim 1, wherein the controller selects, from among the plurality of directions of arrival, a direction of arrival having the highest received signal strength.

4. The power transmission device according to claim 1, wherein the controller selects, from among the plurality of directions of arrival, a direction of arrival having an angle difference from a direction parallel or horizontal to a mounting surface of the power transmission device which is greater than a threshold.

5. The power transmission device according to claim 1, wherein the controller selects, from among the plurality of directions of arrival, the direction of arrival having a greatest angle difference from a direction parallel or horizontal to a mounting surface of the power transmission device.

6. The power transmission device according to claim 1, wherein the controller sets a first weight for the selected direction of arrival to be higher than a second weight for other directions of arrival, performs carrier sensing at a radio frequency used for the transmission beamforming based on reception sensitivity according to the first and second weights, and selects a direction of arrival if no carrier is detected.

7. The power transmission device according to claim 1, wherein the controller:
sets a first weight for a first direction of arrival being the selected direction of arrival to be higher than a second weight for other directions of arrival;
performs first carrier sensing at a radio frequency used for the transmission beamforming based on reception sensitivity according to the first and second weights; and
if a carrier is detected, sets a third weight for a second direction of arrival other than the first direction of arrival among the plurality of arrival directions to be higher than a fourth weight for remaining directions of arrival other than the second direction of arrival among the plurality of arrival directions, and
performs a second carrier sense at the radio frequency used for the transmission beamforming based on a reception sensitivity according to the third and fourth weights.

8. The power transmission device according to claim 1, wherein
the controller:
detects a position of the power receiving device based on the signal;
calculates distances between the plurality of antennas and the power receiving device based on the positions of the antennas and the power receiving device; and
determines weights for the antennas such that phases of signals transmitted from the antennas coincide at the power receiving device; and
the transmitter performs transmission beamforming of the power signal based on the weights.

9. The power transmission device according to claim 1, wherein the controller predicts a position of the power receiving device, which is mounted on a mobile object, for each future timing based on information obtained from the mobile object, and adjusts the selected direction of arrival based on the predicted position to perform transmission beamforming of the power signal.

10. The power transmission device according to claim 9, wherein the information obtained from the mobile object includes at least one of:
captured image data obtained by imaging the mobile object with a camera,
meter information or battery level information of the mobile object, or
movement schedule information of the mobile object.

11. The power transmission device according to claim 1, wherein in the direction-of-arrival estimation, the controller calculates a distribution of signal strength by angle based on the received signal, and detects an angle having a peak in the distribution as the direction of arrival.

12. The power transmission device according to claim 1, wherein the signal received by the receiver includes signals received via a plurality of propagation paths from the power receiving device.

13. The power transmission device according to claim 1, wherein the signal is a beacon signal.

14. A power transmission method comprising:
receiving a signal from a power receiving device via a plurality of antennas;
detecting a plurality of directions of arrival of the signal by performing direction-of-arrival estimation based on the received signal;
selecting one of the plurality of directions of arrival; and
performing transmission beamforming of a power signal with directivity toward the selected direction of arrival.

15. A power supply system comprising a power transmission device and a power receiving device, wherein:
the power receiving device includes a receiving-side transmitter configured to transmit a signal to the power transmission device;
the power transmission device includes:
a receiver configured to receive the signal from the power receiving device via a plurality of antennas;
a controller configured to detect a plurality of directions of arrival of the signal by performing direction-of-arrival estimation based on the received signal, and selects one of the plurality of directions of arrival; and
a transmission-side transmitter configured to perform transmission beamforming of a power signal with directivity toward the selected direction of arrival; and
the power receiving device includes:
a receiver configured to receive the power signal from the power transmission device; and
a battery configured to store power based on the power signal.
